(19) United States
(12) Patent Application Publication
(10) Pub. No.: US 2025/0045622 A1
(43) Pub. Date: Feb. 6, 2025

(54) BATCH SCHEDULING FOR EFFICIENT EXECUTION OF MULTIPLE MACHINE LEARNING MODELS

(71) Applicant: NVIDIA Corporation, Santa Clara, CA (US)

(72) Inventors: Shekhar Dwivedi, Santa Clara, CA (US); Rahul Choudhury, Livermore, CA (US)

(21) Appl. No.: 18/230,311

(22) Filed: Aug. 4, 2023

(51) Int. Cl. G06N 20/00

(52) U.S. Cl. CPC G06N 20/00

(57) ABSTRACT

Apparatuses, systems, and techniques for efficient profiling, scheduling, and batch execution of multiple machine learning models (MLMs). Efficient batch execution includes obtaining execution metrics characterizing expected utilization of computational resources by the MLMs, and generating at least one batch queue having one or more MLM batches of MLMs with a combined expected utilization not exceeding a threshold utilization, and initiating parallel execution of the MLMs using the generated MLM batches.

### TECHNICAL FIELD

At least one embodiment pertains to processing resources used to perform and facilitate artificial intelligence. For example, at least one embodiment pertains to efficient deployment of multiple machine learning models.

### BACKGROUND

Machine learning is often used in many settings, such as office and hospital environments, medical imaging, robotic automation, security applications, autonomous transportation, law enforcement, among others. In particular, machine learning has applications in audio and video processing, such as in voice, speech, and object recognition. One popular approach to machine learning involves training a computing system using training data (sounds, images, actions, face expressions, texts, and/or other data) to identify patterns in the data that may facilitate data classification, such as the presence of a particular type of an object within a training image or a particular word within a training speech or text. Training can be supervised or unsupervised. Machine learning models can use various computational algorithms, such as decision tree algorithms (or other rule-based algorithms), artificial neural networks, and the like. After a deployment of a successfully trained machine learning model, new data is input into the trained machine learning model during an inference stage and various target objects, sounds, sentences, actions, an/or any other target patterns can be identified using patterns and features learned during training.

### BRIEF DESCRIPTION OF DRAWINGS

FIG. 1A is a block diagram of an example architecture of a computing system that supports efficient batch execution of multiple models, in accordance with at least some embodiments;

FIG. 1B illustrates an example inference server capable of supporting efficient batch execution of multiple models, according to at least one embodiment;

FIG. 2 is a block diagram of a component of an inference server that performs efficient profiling, scheduling, and batch execution of multiple models, according to at least one embodiment;

FIG. 3 illustrates schematically operations of a model profiler during evaluation stage of multi-model batch execution, according to at least one embodiment;

FIG. 4 illustrates schematically operations of a batch queue optimizer during batch queue generation stage of multi-model batch execution, according to at least one embodiment;

FIG. 5 is a flow diagram of an example method of initial batch queue generation to support multi-model batch execution, according to at least one embodiment;

FIG. 6 is a flow diagram of an example method of generation of additional batch queues during multi-model batch execution, according to at least one embodiment;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment;

FIG. 10 is a system diagram for an example system for training, adapting, instantiating and deploying machine learning models in an advanced computing pipeline, according to at least one embodiment.

### DETAILED DESCRIPTION

Machine learning (ML) has become a staple in a variety of industries and activities where at least some levels of perception and/or decision-making can be delegated to computer systems. Presently, an increasing number of progressively more complex machine learning models (MLMs) are often applied to processing large amounts of data, including streaming data. For example, multiple MLMs may be used to process a stream of large medical images, e.g., each large image depicting a substantial part of a patient's body. Large images may be cropped into smaller portions depicting individual organs that may be processed by multiple individual MLMs trained to perform inference on a particular cropped portion of the large image. The MLMs may diagnose the presence of various pathologies of organs depicted in the respective cropped portions and output inference predictions (classifications), such as types, locations, and severity of the discovered pathologies. Additional MLMs may process patients' medical records, records of laboratory testing, and the like. Further MLMs may include conversational (language) models trained to process patients' self-assessments, and the like.

Presently, execution of multiple MLMs on a single processing unit or a set of processing units poses significant efficiency challenges. More specifically, sequential execution of different MLMs is slow and results in underutilization of processing units (e.g., central processing units (CPU), graphics processing units (GPU), and/or the like), system memory, GPU memory, input/output (IO) devices, and so on. Parallel execution of multiple MLMs is faster and leads to a much better resource utilization but involves the risk that available memory (and/or computing) resources may be overwhelmed. For example, a combined peak memory utilization by multiple MLMs executed in parallel may exceed a total memory capacity, causing parallel execution to crash. Additionally, managing multiple MLMs is a complex and computationally costly task.

Aspects and embodiments of the present disclosure address these and other challenges of the modern technology by providing for methods and systems that enable batch scheduling and execution of multiple MLMs with efficient protections against overutilization of resources. More specifically, disclosed batching and scheduling mechanisms may involve two-stage techniques. During the first stage, a model profiler may obtain various execution metrics characterizing expected execution of individual MLMs. The execution metrics may include a size of input data into a specific MLM, average memory and/or peak memory (e.g., GPU memory, system memory, etc.) required for execution of the MLM, average processing clock speed and/or peak processing clock speed used for execution of the MLM, and so on. In some embodiments, the execution metrics may be measured during actual (runtime) execution of the MLM, e.g., a previous execution of the MLM or a dedicated testing run of the MLM. In some embodiments, the execution metrics may be estimated without actual execution of the MLM, e.g., based on the MLM architecture, which may include a number of neuron layers of the MLM, a number of neurons in different layers (including the input layer), a number format (e.g., integer, floating-point, etc.) of the input data, intermediate data, output data, and/or the like. The collected (measured or estimated) may be stored in memory (e.g., cache, system memory, hard drive) and loaded during a second, MLM scheduling, stage (as well as reused during future executions of the same MLMs).

During the second stage, various MLMs may be ranked according to a suitable set of priority factors, including importance of a specific MLM relative to other MLMs, resource utilization by the MLM, and/or the like. The ranked MLMs may be placed in a priority queue according to the rankings and then evaluated, based on the execution metrics for inclusion into one of batches that are being formed by a batching algorithm. The batching algorithm may place individual MLMs into batches in a way that results in an efficient utilization of hardware resources. Efficient utilization may limit a combined peak memory (and/or compute) utilization to a certain threshold utilization T (e.g., T=80%, 85%, 90%, or any other value) while at the same time favoring formation of batches with combined peak utilizations that are as close to T as possible. For example, the batching algorithm may favor placement of three MLMs with peak memory utilizations of 35%, 28%, and 20% into a single batch over placement of two MLMs with peak memory utilizations of 40% and 37%, respectively, if the threshold utilization is T=85%. The evaluated MLM may be placed in one of the existing batches, if the receiving batch has sufficient available utilization space to accommodate the MLM. If no available batch is capable of accommodating the MLM (no batch has a sufficient utilization space), the MLM may be placed into a new batch. This evaluation process may be repeated until all MLMs are placed into batches. The set of batches forms a batch queue. Once an initial (first) batch queue is formed, a batch scheduler may begin execution of MLMs of the first batch, followed by execution of the second batch, third batch, and so on.

In parallel with the initial batch execution, a batching algorithm may continue optimization of batches. In some embodiments, batch optimization may be performed purely algorithmically, using the same execution metrics measured (or estimated) during the first stage. During batch optimization, some of the existing batches may be modified (with one or more MLMs moved between the batches), some of the existing batches may be eliminated altogether, new batches may be created, and/or so on. In some embodiments, batch optimization may be performed using runtime metrics measured during the current execution of the first queue. In some instances, a combination of previously obtained metrics and newly measured metrics be used, e.g., new metrics may be used for the MLMs that have already been executed while previously obtained metrics may be used for the MLMs that are yet to be executed.

As the new batches and, correspondingly, batch queues are formed, not yet executed MLMs may be rescheduled according to the new batch queue(s). In those instances where execution of the MLMs is cyclical (e.g., a new cycle is used to process each new incoming set of input data, such as new patients' images), the updated batch queue may be used in subsequent cycles of the MLM execution. In some embodiments, one or more batch queues with (estimated and/or measured) execution metrics for different generated batches/batch queues may be provided to a user, and the user may select one of the generated batch queues for execution. Additionally, the most optimal batch queue and/or the batch queue selected by the user may be stored for later use with the same set of the MLMs (or sets that have at least some of the same MLMs).

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems implemented using one or more application programming interfaces; systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### System Architecture

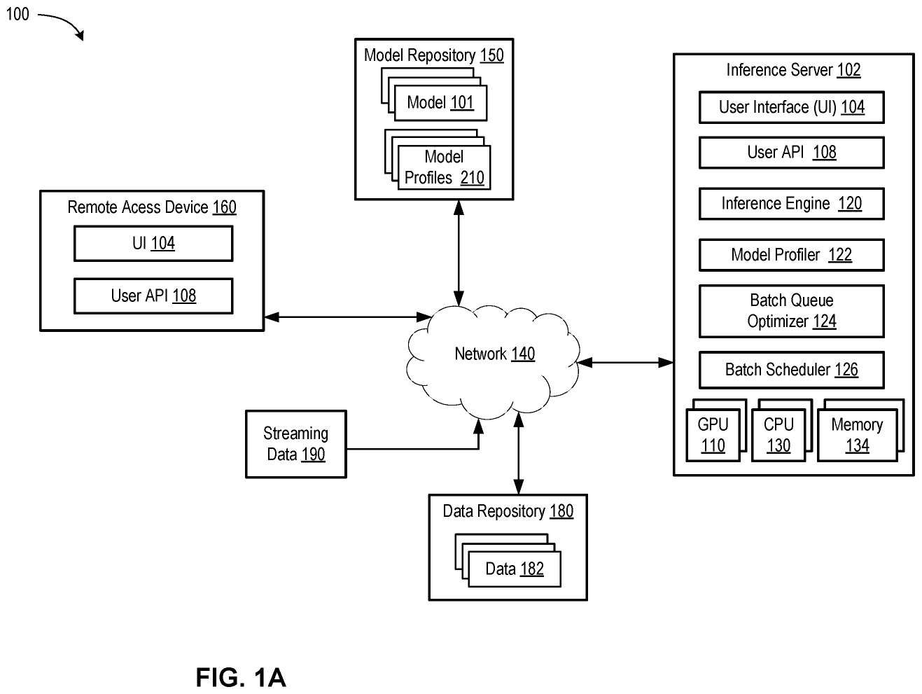

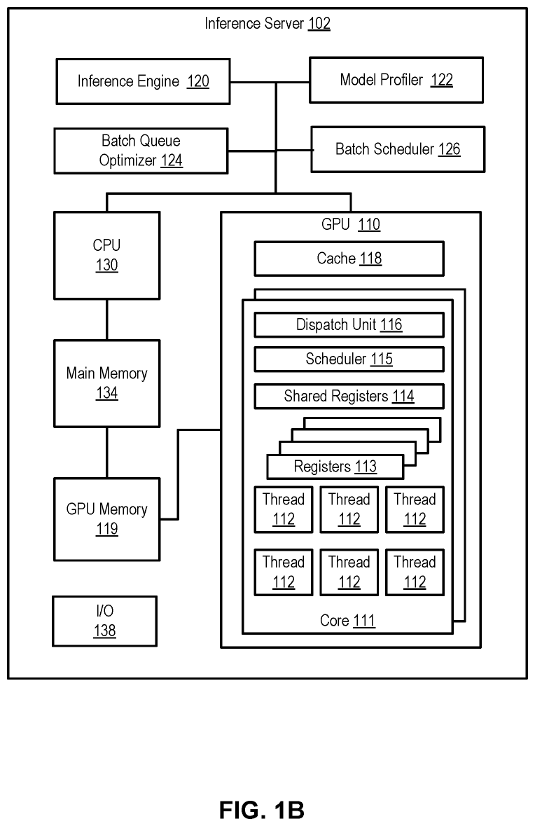

FIG. 1A is a block diagram of an example architecture 100 of a computing system that supports efficient batch execution of multiple models, in accordance with at least some embodiments. As depicted in FIG. 1A, example architecture 100 may be implemented on multiple computing devices, e.g., inference server 102, remote access device 160, and so on, and may use multiple storage repositories, including but not limited to a model repository 150 and data repository 180. Any of the servers, storages, modules and components of example architecture 100 may be implemented using cloud computing. In some embodiments, any of the modules and components of example architecture 100 may be implemented using more or fewer devices than are shown in FIG. 1A. In some embodiments, some (e.g., all) modules and components of example architecture 100 may be implemented on a single computing device (e.g., inference server 102), including but not limited to a computing device local to a user of example architecture 100.

Inference server 102 may be or include a desktop computer, a laptop computer, a smartphone, a tablet computer, a server, a computing device that accesses a remote server, a computing device that utilizes a virtualized computing environment, a gaming console, a wearable computer, a smart TV, and/or any combination thereof. A user may have a local or remote (e.g., over a network) access to inference server 102. For example, the user may access inference server 102 via a remote access device 160, which may be any type of computing device referenced above in conjunction with inference server 102, or any other type of computing device, or a combination of multiple computing devices. Inference server 102 may have any number of graphics processing units (GPUs) 110, central processing units (CPUs) 130, parallel processing units (PPUs), data processing units (DPUs), or accelerators, and/or other suitable processing devices capable of performing the techniques described herein. GPU 110 and/or CPU 130 may support any number of virtual CPUs and/or virtual GPUs. Inference server 102 may include any number of memory devices, also referred to simply as memory 134 herein. Inference server 102 may also include network controllers, peripheral devices, and the like. Peripheral devices may include cameras (e.g., video cameras) for capturing images (or sequences of images), microphones for capturing sounds, scanners, sensors, or any other devices for intake of data.

In some embodiments, inference server 102 may include a number of engines and components to facilitate efficient execution of multiple models. A user (customer, end user, developer, data scientist, etc.) may interact with inference server 102 via a user interface (UI) 104, which may include a command line, a graphics-based UI, a web-based UI (e.g., a web browser-accessible interface), a mobile application-based UI, or any combination thereof. UI 104 may display menus, tables, graphs, flowcharts, graphical and/or textual representations of software, dataflows, and workflows. UI 104 may include selectable items, which may enable the user to enter various configuration settings, identify models to be deployed, location of input data to be processed, and/or destinations for output data, and the like. The configuration settings may include priority metrics for ranking models and performance metrics for evaluating efficiency of model execution on a set of available computational resources, e.g., GPU 110, CPU 130, memory 134, memory of GPU 110, and/or the like. User actions and configuration settings entered via UI 104 may be communicated to inference engine 120 and/or a model profiler 122 via a user API 108. In some embodiments, UI 104 and user API 108 may be located on remote access device 160 that the user is using to access inference engine 120 and model profiler 122. For example, an API package with user API 108 and/or user interface 104 may be downloaded to remote access device 160. The downloaded API package may be used to install user API 108 and/or user interface 104 to enable the user to have two-way communication with inference engine 120 and model profiler 122.

User API 108 may provide to the user a set of commands that can be understood by inference engine 120 and model profiler 122 as instructions to deploy multiple user-specified models 101 (also referred to as MLMs herein) and use the deployed models to evaluate data, which may include data 182 stored in data repository 180 and/or streaming data 190, e.g., data generated at runtime by any sensors, such as imaging sensors, video sensors, audio sensors, physical sensors, chemical sensors, and/or any other suitable sensors, and/or combinations thereof. The commands, made available via user API 108, may include commands that identify locations where models 101 are stored (or temporarily held), commands that identify where data to be input into models 101 is stored or originated (e.g., in case of inference of streaming data 190), commands that indicate specific inference backends to be used with various models 101. The commands may further include identification of a number format to be used during inference computations (e.g., integer, half-precision, full precision format, etc.), and/or the like. The commands may specify how different models 101 are to be prioritized during execution by the inference engine 120, what threshold utilization T to use during batch scheduling, and the like. Individual commands may be input by the user using statements, menus, selectable graphical items, etc., that are native to (or supported by) the user API 108.

Using commands received from the user, inference engine 120 may configure execution of user-selected models using suitable inference backends on one or more processing devices (e.g., GPUs 110, CPUs 130, etc.), which may be default processing devices, processing devices selected by inference engine 120, or user-selected processing devices. Some of the commands may configure model profiler 122 to evaluate expected execution of individual models 101, e.g., by specifying execution metrics characterizing expected utilization of the set of computational resources of inference server 102. For example, specified execution metrics may include some or all of the following: a size of input data into a specific model 101, average memory and/or peak memory (e.g., GPU memory, system memory, etc.) required for execution of the model, average processing clock speed and/or peak processing clock speed used for execution of the MLM, and so on. The execution metrics specified by the user may be weighted using default weights or weights specified by the user.

Model profiler 122 may obtain execution metrics for various models 101 selected by the user for execution. In some embodiments, the execution metrics may be obtained (measured) during actual (runtime) execution of a model, which may be an earlier (historical) execution of the model or a separate testing run of the model (e.g., if previous execution data is not available). In some embodiments, the testing run may be scheduled prior to inference, responsive to the user identifying models 101. Various identified models with absent historical execution metrics may undergo test execution (e.g., sequentially, one after another) and execution metrics may be collected. In some embodiments, model profiler 122 may estimate execution metrics of various models without an actual (historical or scheduled) test execution. Estimation may be based on analysis of the models' architecture, a size of an input into the model, a number of computational operations associated with the model (e.g., a number and type of neural nodes in various neural layers of the model), number formats used by the model (e.g. INT8, INT16, FP16, FP32, and the like).

The execution metrics obtained by model profiler 122 may be stored as part of model profiles 210 (e.g., in model repository 150 or on inference server 102) and used by batch queue optimizer 124 to generate a set of batches for execution by inference engine 120. For example, various models may be ranked according to a suitable set of priority factors (metrics), including importance of the model relative to other models (e.g., a safety-sensitive model may be given a higher priority than a model that identifies secondary features), resource utilization by the model (e.g., a model requiring large memory spaces may be given a higher priority), and/or the like. The models ranked by priority may be placed in a priority queue and evaluated by batch queue optimizer 124 for inclusion into one of the batches. For example, batch queue optimizer 124 may form multiple batches, with individual batches having one or more models to be executed in parallel without exceeding a utilization threshold, which may be set by the user or be a default threshold. Once a first (initial) batch queue of batches is formed, a batch scheduler 126 may schedule serial execution of consecutive batches with models assigned to individual batches executed in parallel. In some implementations, batch queue optimizer 124 may continue optimization of the batches even after execution of batches has started. This may lead to generation of additional batch queues, which may be more optimal than the first batch queue. One or more of the generated batch queues may be stored in memory 134 (or in model repository 150) for future use, e.g., during future instances of execution of the same set of models or sets of models that include at least some of the same models.

Inference backends used by inference engine 120 for execution of models should be understood as any software resources, packages, toolkits, software development kits (SDKs), which are capable of executing on suitable hardware, including but not limited to one or more GPUs 110, one or more CPUs 130, and any other processing resources. Individual backends may include executable codes, libraries, and configuration files. Inference backends may include but need not be limited to TensorFlow® backends, PyTorch® backends, TensorRT® backends, ONNX® backends, and/or the like. In some embodiments, at least some of the functionality of inference server 102 may be supported by (e.g., split between) multiple computing devices.

Models 101 may be pre-trained and stored on inference server 102 or in model repository 150 accessible to inference server 102 over a network 140. Network 140 may be a public network (e.g., the Internet), a private network (e.g., a local area network (LAN), or wide area network (WAN)), a wireless network, a personal area network (PAN), or a combination thereof. Models 101 may include regression algorithms, decision trees, support vector machines, K-means clustering models, neural networks, or any other machine learning algorithms. Neural network MLMs may include convolutional, recurrent, fully-connected, Long Short-Term Memory models, Hopfield, Boltzmann, or any other types of neural networks. Generating MLMs may include setting up an MLM type (e.g., a neural network), architecture, a number of layers of neurons, types of connections between the layers (e.g., fully connected, convolutional, deconvolutional, etc.), the number of nodes within each layer, types of activation functions used in various layers/nodes of the network, types of loss functions used in training of the network, and so on. Generating models 101 may include setting (e.g., randomly) initial parameters (weights, biases) of various nodes of the networks. The generated models 101 may be trained by using training data that may include training input(s) and corresponding target output(s).

For example, for training of speech recognition models, training inputs may include one or more digital sound recordings with utterances of words, phrases, and/or sentences that the MLM is being trained to recognize. Target outputs may include indications of whether the target words and phrases are present in the training inputs. Target outputs may also include transcriptions of the utterances, and so on. In some embodiments, target outputs may include identification of a speaker's intent. For example, a customer calling a food delivery service may express a limited number of intentions (to order food, to check on the status of the order, to cancel the order, etc.) but may do so in a practically unlimited number of ways. Whereas specific words and sentences uttered may not be of much significance, determination of the intent may be important. Accordingly, in such embodiments, target outputs may include a correct category of intent. Similarly, a target output for a training input that includes an utterance of a client calling a customer service phone may be both a transcription of the utterance as well as an indication of an emotional state of the client (e.g., angry, worried, satisfied, etc.). During training of models 101, a training software may identify patterns in training input(s) based on desired target output(s) and train the respective models 101 to perform desired tasks. Predictive utility of the identified patterns may subsequently be verified using additional training input/target output associations before being used, during the inference stage, in future processing of new speeches. For example, upon receiving a new voice message, a trained model 101 may be able to identify that the customer wishes to check on the status of a previously placed order, identify the name of the customer, the order number, and so on.

FIG. 1B illustrates an example inference server 102 capable of supporting efficient batch execution of multiple models, according to at least one embodiment. In at least one embodiment, inference engine 120, model profiler 122, batch queue optimizer 124, batch scheduler 126, and/or other programs and applications may be executed using one or more GPUs 110 (and/or other parallel processing units (PPUs) or accelerators, such as a deep learning accelerator, a data processing unit (DPU), etc.) and one or more CPUs 130. In at least one embodiment, a GPU 110 includes multiple cores 111, some or all cores being capable of executing multiple threads 112. Some or all cores may run multiple threads 112 concurrently (e.g., in parallel). In at least one embodiment, threads 112 may have access to registers 113. Registers 113 may be thread-specific registers with access to a register restricted to a respective thread. Additionally, shared registers 114 may be accessed by one or more (e.g., all) threads of the core. In at least one embodiment, some or all cores 111 may include a scheduler 115 to distribute computational tasks and processes among different threads 112 of respective core 111. A dispatch unit 116 may implement scheduled tasks on appropriate threads using correct private registers 113 and shared registers 114. Inference server 102 may include input/output component(s) 138 to facilitate exchange of information with one or more users or developers.

In at least one embodiment, GPU 110 may have a (high-speed) cache 118, access to which may be shared by multiple cores 111. Furthermore, inference server 102 may include a GPU memory 119 where GPU 110 may store intermediate and/or final results (outputs) of various computations performed by GPU 110. After completion of a particular task, GPU 110 (or CPU 130) may move the output to (main) memory 134. In at least one embodiment, CPU 130 may execute processes that involve serial computational tasks whereas GPU 110 may execute tasks (such as multiplication of inputs of a neural node by weights and adding biases) that are amenable to parallel processing. In at least one embodiment, inference engine 120 may determine which processes are to be executed on GPU 110 and which processes are to be executed on CPU 130.

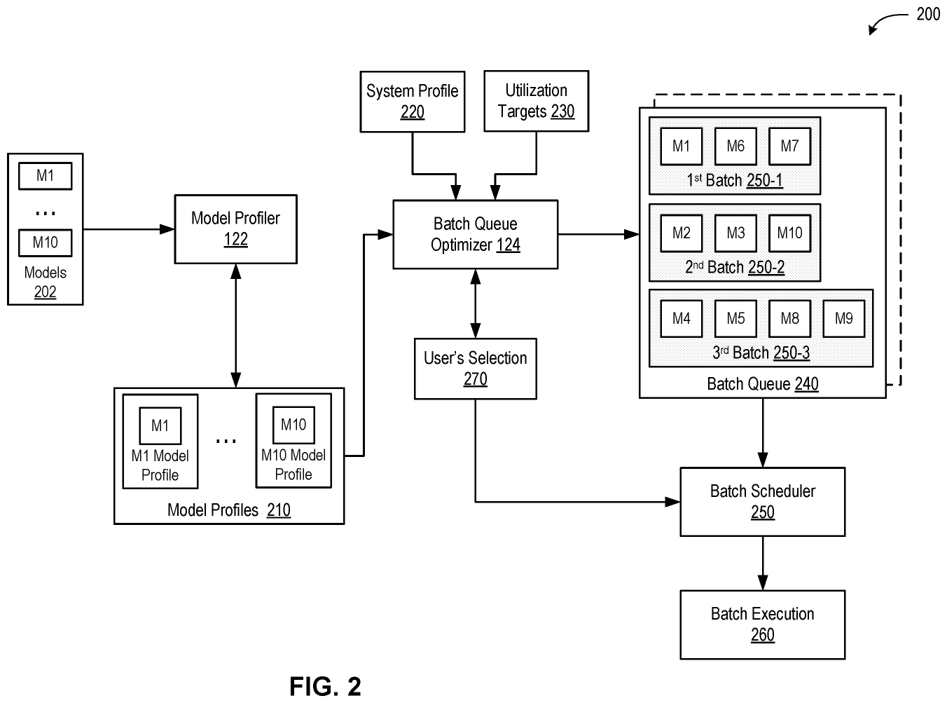

FIG. 2 is a block diagram of a component 200 of inference server 102 that performs efficient profiling, scheduling, and batch execution of multiple models, according to at least one embodiment. For conciseness and ease of viewing, FIG. 2 illustrates scheduling and execution of ten models 202, namely models M1 . . . M10, but execution of any number of models 202 may be supported with techniques disclosed herein. Models 202 may be selected by a user or identified by any suitable application as part of that application's package. For example, models 202 may be identified during loading of a medical diagnostics application that processes medical records, images, laboratory testing results, self-assessments, and/or the like. Model profiler 122 may obtain execution metrics for models 202 selected by the user for execution. Execution metrics may be measured during a previous execution of model 202 and then stored as model profiles 210 (models requirements cache), e.g., in system memory or on a hard drive/flash memory. Execution metrics {mᵢ}=m₁, m₂ . . . m_{N} for a specific model 202 may include an identification and a size of input data into the model, an average/total memory and/or peak memory (e.g., GPU memory, system memory, etc.) used during execution of the model, average processing clock speed and/or peak processing clock speed during execution of the model, and other similar metrics.

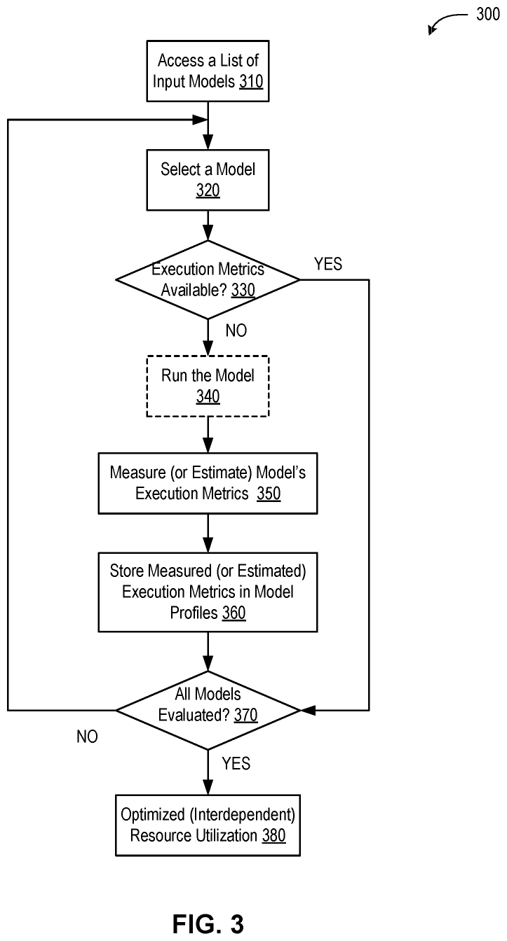

FIG. 3 illustrates, schematically, operations 300 of model profiler 122 during evaluation stage of multi-model batch execution, according to at least one embodiment. As illustrated in FIG. 3, model profiler 122 may receive a list of models (block 310) for batch execution. Model profiler 122 may select a model from the list (block 320) and determine whether model profiles 210 include stored execution metrics {mᵢ} for the model (block 330). If the execution metrics are not available for the model, model profiler 122 may perform a test run (block 340) for the model and measure the execution metrics during the test run (block 340). The measured metrics may then be stored in model profiles 210 for future use. In some instances, model profiler 122 does not perform a test run for the model, e.g., when the models are associated with a time-sensitive application and performing test runs incurs an undesired time delay. In such instances, model profiler 122 may (at block 350) estimate execution metrics of the model algorithmically. The estimation may be based on various known (e.g., from configuration files) properties of the models, e.g., a size of an input data processed by the model, numbers and types of neural nodes in various neural layers (or other computational operations of the models) of the model, size and type of numbers used in computations of the model, and so on. models without an actual (historical or scheduled) test execution. The estimated execution metrics may similarly be stored (at block 360) in model profiles 210. The estimated execution metrics may subsequently be replaced, in model profiles 210, with more accurate execution metrics measured during an actual running of the model. Test runs/estimations for different models may be performed sequentially. This may prevent distortion of one model's execution by a parallel execution of other models. Accordingly, if model profiler 122 determines that not all models have been evaluated (at block 370), the next model on the list of models may be selected and the evaluation (blocks 330-360 may be repeated).

After multiple (all, in some embodiments) models have been evaluated, model profiler 122 may perform additional analysis of stored execution metrics and identify interdependent resource utilization (block 380) by multiple models. For example, model profiler 122 may identify input data shared by two or more models (e.g., same input images, speech utterances, sensor data, and/or the like) and cross-reference such models. For example, if models M1, M5, and M8 share the same input data (or a portion of input data), model profiler 122 may place corresponding annotations into model profiles of these models. Such annotations may indicate (e.g., to batch queue optimizer 124) that parallel execution of cross-referenced models is beneficial since such parallel execution reduces the total memory usage compared with independent execution of the models. Interdependencies of models may also exist if one model, e.g., model M2 uses (as an input) an output of model M1. In this instance, the annotations may indicate that model M2 is to be executed sequentially with respect to model M2.

Referring again to FIG. 2, after model profiler 122 creates, verifies the presence, or updates model profiles 210, batch optimizer 124 may generate batches of models and place the generated batches in an initial batch queue. For example, as illustrated in FIG. 2, a first batch 250-1 may include three models M1, M6, and M7, a second batch 250-2 may include three models M2, M3, and M10, and a third batch 250-3 may include four models M4, M5, M8, and M9. Batch optimizer 124 may use, as inputs, model profiles 210 that predict how various models will utilize resources during execution and whether utilization interdependencies exist (e.g., either favoring or disfavoring parallel execution of some models). Batch optimizer 124 may use, as further input, a system profile 220, which may indicate computational resources available to a computing device that is to perform model execution, e.g., inference server 102. For example, system profile 220 may indicate a number of GPUs and/or CPUs accessible to inference server 102, a number of physical cores and/or virtual units in GPUs and/or CPUs cores, the volume of GPU memory, CPU memory, available network bandwidth, IO bandwidth, and/or other hardware resources.

Batch optimizer 124 may also use, as input, utilization targets 230. Utilization targets 230 may include a target utilization T, e.g., a combined peak utilization (or some other suitable aggregated resource utilization) by models that are executed in parallel (e.g., models of a single batch). The target utilization T may correspond to the maximum resource utilization that is not to be exceeded by individual batches 250-j. At the same time, the combined resource utilization by various batches 250-j may be made as close to the target utilization T as practical, to minimize resource underutilization. Utilization targets 230 may further include priority metrics for ranking priority of execution of various models 202. For example, the priority metrics may have numerical values (e.g., P=1, 2, 3 . . . ) or symbolic values (e.g., P=High, Medium, Low, and so on) and may indicate the relative importance of different models 202 (or outputs of different models 202). In some embodiments, the priority metrics may indicate whether different models 202 are to be prioritized by resource utilization, by duration of execution, and the like. For example, the priority metrics may favor models with high resource utilization (e.g., models that need a large volume of memory, a large number of computational cycles, and so on) over models with low resource utilization. Accordingly, if it is important that the time between a first output (generated by any of models 202) and a last output be minimized, the priority metrics may favor placing models with a high resource utilization near the front of the execution queue and placing models with a low resource utilization near the back end of the execution queue. Conversely, if it is important that the first output be generated as quickly as possible, the priority metrics may favor placing models with a low resource utilization near the front of the execution queue. When multiple priority metrics are defined, utilization targets 230 may also include weights assigned to different priority metrics. Any of utilization targets 230 (e.g., threshold utilization, priority metrics, weights, and the like) may be specified by user (e.g., via user API 108). Utilization targets 230 that are not user-specified may be given default values, e.g., as specified by a suitable library of batch queue optimizer 124.

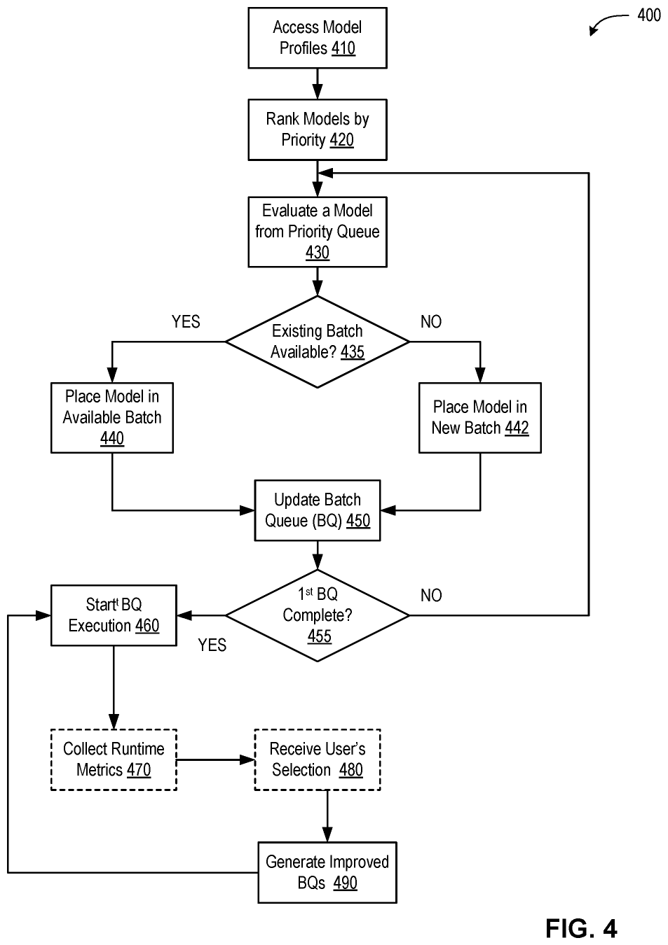

FIG. 4 illustrates, schematically, operations 300 of batch queue optimizer 124 during a batch queue generation stage of multi-model batch execution, according to at least one embodiment. As illustrated in FIG. 4, batch queue optimizer 124 may access model profiles 210 (block 410). Batch queue optimizer 124 may rank various models 202 according to the received priority metrics and place the models in a priority queue according to the rankings (block 420). Batch queue optimizer 124 may select a model from the priority queue, e.g., starting from the highest priority model, and may evaluate the selected model based on the execution metrics (block 430) for inclusion into one of batches 250-j. The first (top priority) model may be placed in the first batch. The second model from the priority queue may be first evaluated for inclusion into the first batch (e.g., the batch that will be executed first). If the first batch is capable of accepting the second model without the combined utilization by the first model and the second model exceeding the threshold utilization T (decision-making block 435), the second model may be placed into the existing first batch (block 440). If the first batch cannot accept the second model without exceeding the threshold utilization T, batch queue optimizer 124 may create a new (second) batch and place the second model into the second batch. The second batch is then placed into the batch queue after the first batch (block 450).

Operations of blocks 430-450 may be similarly performed for the remaining models in the priority queue. Each subsequent model may be evaluated for inclusion into one of the existing batches and, if no existing batch is capable of accepting the evaluated model, a new batch may be created for the model. This evaluation process may be repeated until all models are placed into batches (block 455). Once an initial (first) batch queue is formed, a batch scheduler (e.g., batch scheduler 250 of FIG. 2) may start execution of the first batch queue (block 460). Execution of the first batch queue may start batch execution 260 (with reference to FIG. 2) of the first batch, followed by execution of the second batch, and so on. For example, execution of the first batch queue 240 may begin with parallel execution of models M1, M6, and M7 of the first batch 250-1. After execution of the models of the first batch 250-1, batch execution 260 may continue with execution of models M2, M3, and M10 of the second batch 250-2, and so on.

In parallel with execution of the first batch queue, batch queue optimizer 124 may continue optimization of the batches and may generate one or more additional batch queues. In some embodiments, batch optimization may be performed purely algorithmically, with batch queue optimizer 124 generating a more optimal batch queue (block 490). For example, a more optimal batch queue may have fewer batches with various batches having combined utilizations that is closer to (but not exceeding) the threshold utilization T. More specifically, some of the existing batches may be modified by moving one or more models 202 between the batches, some of the existing batches may be eliminated altogether, new batches may be created, and so on. Various mathematical algorithms may be used for batch optimization, including but not limited to traveling salesman algorithms, pairwise exchange algorithms, nearest neighbor algorithms, or other greedy algorithms.

In some embodiments, optimization may be performed using runtime execution metrics collected during execution of the first queue (block 470). The runtime execution metrics may differ from the previously obtained (estimated, historical, or test run) metrics used in generating the first queue. In some embodiments, a combination of the previously obtained metrics and newly measured runtime metrics be used, e.g., the newly measured metrics may be used for the models that have already been executed (as part of the first queue execution) while previously obtained metrics may be used for those models that are yet to be executed.

As the new batches and, correspondingly, one or more improved batch queues are formed, the not yet executed models may be rescheduled according to one of the improved batch queues (e.g., a queue with the total utilization across batches being closest to the target utilization T). In those instances where execution of the models is cyclical (e.g., a new cycle is used to process each new incoming set of input data), one of the improved batch queues may be used in subsequent cycles of the execution of models 202. The most optimal batch queue (or several most optimal batch queues) may be stored for later use with the same set (or similar sets) of the models 202.

In one example non-limiting embodiment, a set of execution metrics {mᵢ} weighted according to any suitable wet of weights {wᵢ} may be used to compute resource utilization u=Σᵢwᵢ·mᵢ for each model. Metrics mᵢ may be normalized (mᵢ≤1), e.g., GPU memory utilization metric may be represented as a percentage of the total available GPU memory. Weights may be normalized according to the condition, Σᵢwᵢ=1. As a result, resource utilization u for individual models may be within the unit interval u∈[0,1]. Resource utilization for a given batch (indexed by batch number α) may be computed U_{α}=u₁+u₂+ . . . , as the sum of resource utilization for individual models included in the batch. Batch queue optimization may be performed by finding such a distribution of models over batches that, on one hand, ensures that for each batch, U_{α}≤T, while on the other hand, minimizes resource loss (underutilization), e.g.,

$$L = {\sum }_{α} {( T - {U}_{α} )}^{2} ,$$

$$or$$

$$L = {\sum }_{α} {\vert T - {U}_{α} \vert}^{2} ,$$

or some other suitable loss function.

In some embodiments, batch queue optimizer 124 may report one or more batch queues to a user, e.g., the first batch queue being currently executed and one or more additional batch queues. The user may provide user's selection 270 of one of the queues (block 480 in FIG. 4) and batch queue optimizer 124 may modify the first batch queue according to the user's input. For example, batch queue optimizer 124 may replace the first queue, which is currently being executed, with one of the additional queues. In some instances, the user's selection may modify the first (or one of the additional batches) by rearranging the batches, e.g., moving one or more of the models between batches. The user's selection may be informed by a display of runtime metrics associated with execution of the first batch queue and expected metrics of execution of the additional queue(s).

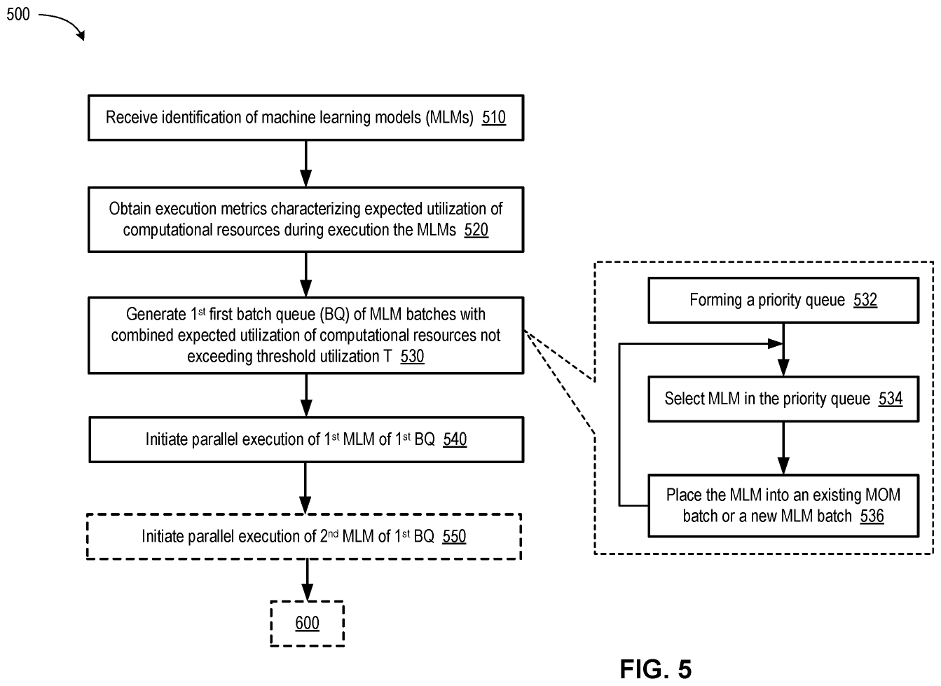

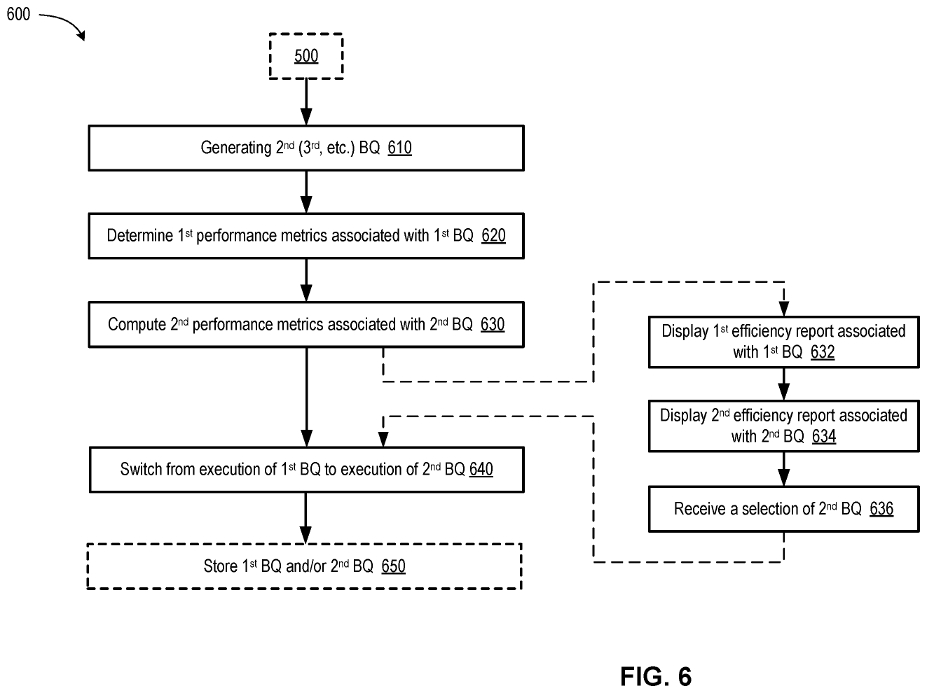

FIG. 5 and FIG. 6 are flow diagrams of example methods 500 and 600, respectively, directed to efficient multi-model batch execution. Methods 500 and 600 may be performed using one or more processing units (e.g., CPUs, GPUs, accelerators, PPUs, DPUs, etc.), which may include (or communicate with) one or more memory devices. In at least one embodiment, methods 500 and 600 may be performed using processing units of inference server 102, the processing units performing instructions of inference engine 120, model profiler 122, batch queue optimizer 124, and/or batch scheduler 126. In at least one embodiment, processing units performing any of methods 500 and/or 600 may be executing instructions stored on a non-transient computer-readable storage media. In at least one embodiment, any of methods 500 and/or 600 may be performed using multiple processing threads (e.g., CPU threads and/or GPU threads), individual threads executing one or more individual functions, routines, subroutines, or operations of the method. In at least one embodiment, processing threads implementing any of methods 500 and/or 600 may be synchronized (e.g., using semaphores, critical sections, and/or other thread synchronization mechanisms). Alternatively, processing threads implementing any of methods 500 and/or 600 may be executed asynchronously with respect to each other. Various operations of any of methods 500 and/or 600 may be performed in a different order compared with the order shown in FIG. 5 and/or FIG. 6. Some operations of any of methods 500 and/or 600 may be performed concurrently with other operations. In at least one embodiment, one or more operations shown in FIG. 5 and/or FIG. 6 may not always be performed. Methods 500 and 600 may involve data (e.g., domain-specific tokens, task data) related to one or more domains where task-oriented dialogue systems may be used. Methods 500 and 600 may also use template queries tailored to the domain(s) in which the task-oriented dialogue system may be used.

FIG. 5 is a flow diagram of an example method 500 of initial batch queue generation to support multi-model batch execution, according to at least one embodiment. At block 510, method 500 may include receiving an identification of a plurality of MLMs for execution on a set of computational resources. The set of computational resources may include one or more CPUs and/or one or more GPUs. At block 520, method 500 may include obtaining execution metrics characterizing expected utilization of the set of computational resources during execution of various individual MLMs of the plurality of MLMs. The execution metrics may characterize expected utilization of the set of computational resources and may include one or more of the following list of non-exclusive metrics: a size of input data into an MLM of the plurality of MLMs, a total memory used during execution of the MLM, a peak memory use during execution of the MLM, a peak processing clock speed during execution of the MLM, and the like. In some implementation, the execution metrics also include expected utilization of one or more virtual processing units supported by the set of computational resources, e.g., one or more virtual GPUs, one or more virtual CPUs, and/or any combination thereof.

In some embodiments, obtaining the execution metrics for any or all MLMs of the plurality of MLMs may include collecting the execution metrics during individual execution of that specific MLM(s). In some embodiments, obtaining the execution metrics for any or all MLM of the plurality of MLMs may include estimating the execution metrics for the specific MLM(s) using an architecture of the MLM(s), a size of an input into the MLM(s), a number of computational operations associated with the MLM(s), number format(s) used by the computational operations associated with the MLM, and/or other metrics. In some embodiments, after the execution metrics are collected (e.g., measured and/or estimated), the processing units performing method 500 may store the collected execution metrics in a memory device.

At block 530, method 500 may continue with generating a first batch queue (e.g., batch queue 240 in FIG. 2) that includes one or more MLM batches (e.g., batches 250-j). Each MLM batch may include one or more MLMs of the plurality of MLMs and may have a combined expected utilization of the set of computational resources not exceeding a threshold utilization T. In some embodiments, the combined expected utilization may characterize expected utilization of memory resources during parallel execution of one or more MLMs of the first MLM batch. In some embodiments, the combined expected utilization may further characterize expected utilization of one or more processing units (e.g., GPU(s) or other processing devices) during parallel execution of the one or more MLMs of the first MLM batch.

In some embodiments, generating the first batch queue may include operations of blocks of the callout portion of FIG. 5. More specifically, at block 532, method 500 may include forming, using a suitable priority metric, a priority queue for the plurality of MLMs. After forming the priority queue, method 500 may continue with a plurality of MLM placement operations. Individual MLM placement operations may include, at block 534, selecting the next MLM in the priority queue and placing, at block 536, the selected MLM, using the threshold utilization and the execution metrics for the selected MLM, into an existing MLM batch of the first batch queue or into a newly-created (for the selected MLM) batch of the first batch queue. Operations of blocks 534 may be repeated until all MLMs on the priority queue has been placed into batches.

At block 540, method 500 may continue with initiating parallel execution of a first MLM batch (e.g., batch 250-1) of the one or more MLM batches of the first batch queue (e.g., batch queue 240). At block 550, responsive to completed execution of the first MLM batch, method 500 may continue with initiating parallel execution of a second (third, etc.) MLM batch (e.g., batch 250-2, batch 250-3, etc.) of the one or more MLM batches of the first batch queue. In some embodiments, execution of a second MLM batch may be initiated concurrently with execution of the first MLM batch. MLMs of the second MLM batch may be executed in parallel. In some embodiments, the first MLM batch and the second MLM may be executed on separate GPUs. In some embodiments, the first MLM batch and the second MLM batch may be executed on separate virtual GPUs supported by the same (physical) GPU.

FIG. 6 is a flow diagram of an example method 600 of generation of additional batch queues during multi-model batch execution, according to at least one embodiment. In some embodiments, method 600 may be performed as part of method 500, e.g., subsequent to initiating execution of the first MLM batch. At block 610, method 600 may include generating a second (third, etc.) batch queue. The second (third, etc.) batch queue may include at least one MLM batch that is different from each MLM batch of the first batch queue.

At block 620, method 600 may include determining first performance metrics associated with execution of the first batch queue. In some instances, the first performance metrics may be measured during execution of various MLMs of the first MLM batch, second MLM batch, and any other MLM batches that have been executed (or are being executed). The first performance metrics may include average memory and/or processor utilization, maximum memory and/or processor utilization, and/or any other statistics associated with the first batch queue execution.

At block 630, method 600 may include computing second performance metrics associated with prospective execution of the second (third, etc.) batch queue. For example, the second performance metrics may be an estimated performance metric(s) for the second (third, etc.) batch queue. The estimation of the second performance metrics may be based (at least partially) on the first performance metrics measured during execution of the MLMs placed in the first batch queue. At block 640, responsive to a comparison of the first performance metrics and the second (third, etc.) performance metrics, the processing device performing method 600 may cause execution of the first batch queue to be switched to execution of the second (third, etc.) batch queue.

In some embodiments, the decision to replace execution of the first batch queue with a different (e.g., second, third, etc.) batch queue may be made by a user. More specifically, as illustrated in FIG. 6, at block 632, method 600 may include displaying (e.g., on UI 104 of FIG. 1) a first efficiency report to the user. The first efficiency report may include runtime performance metrics associated with execution of the first batch queue, e.g., average memory and/or processor utilization, maximum memory and/or processor utilization, and/or any other statistics, metrics, and data associated with the first batch queue execution. At block 634, method 600 may include displaying a second efficiency report to the user. The second (third, etc.) efficiency report may include estimated performance metrics associated with prospective execution of the second batch queue and may include the statistics, metrics, and data of the same (or similar) types as displayed with the first efficiency report. The user may decide to make a change from execution of the first batch queue to execution of the second (third, etc.) batch queue and make the corresponding selection (e.g., via UI 104). At block 636, the processing units performing method 600 may receive, from the user, a selection of the second (third, etc.) batch queue. At block 640, responsive to receiving the user's selection, the processing units may switch from execution of the first batch queue to execution of the second (third, etc.) batch queue. At block 650, method 600 may include storing at least one of the generated batch queues for future use in a memory device.

The systems and methods described herein may be used for a variety of purposes, by way of example and without limitation, for performing one or more operations with respect to systems or methods associated with machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, chat bots, digital avatars, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an in-vehicle infotainment system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for generating or presenting virtual reality content, mixed reality content, or augmented reality content, systems for performing conversational AI operations, systems for performing light transport simulation, systems for performing collaborative content creation for 3D assets, systems implemented at least partially using cloud computing resources, and/or other types of systems.

### Inference and Training Logic

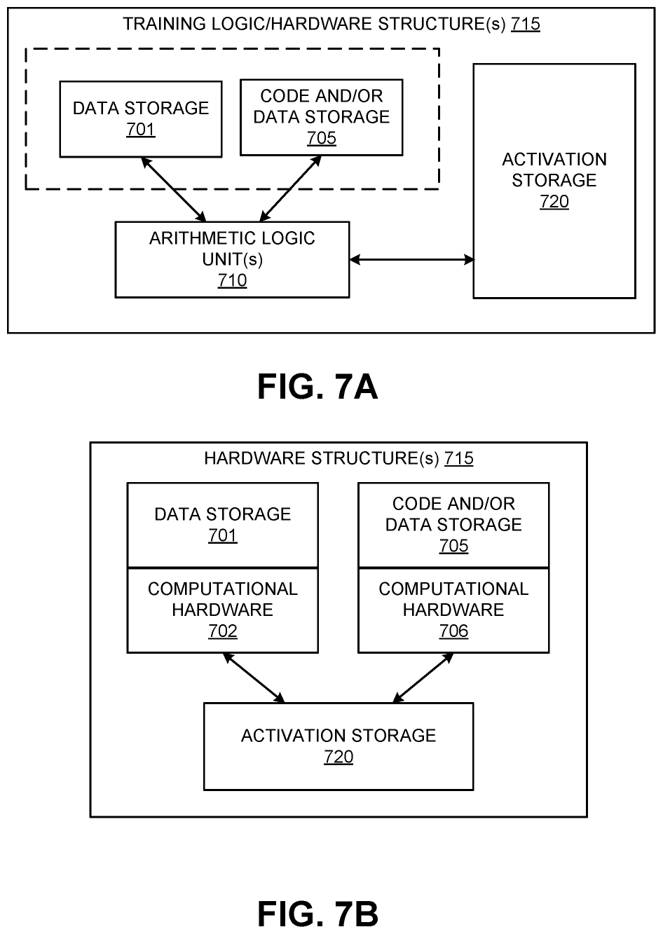

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include (or be coupled to code and/or data storage 701 that stores) graph code or other software to control timing and/or order, in which weight and/or other parameter information is to be loaded to configure processing units, including logic units, integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include (or be coupled to code and/or data storage 705 that stores) graph code or other software to control timing and/or order, in which weight and/or other parameter information is to be loaded to configure processing units, including logic units, integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within the same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, the result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

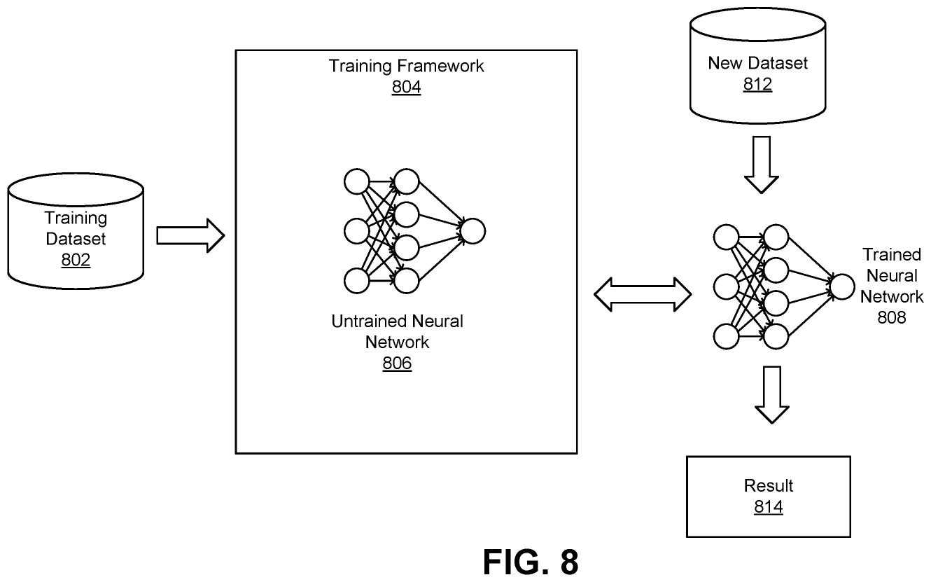

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

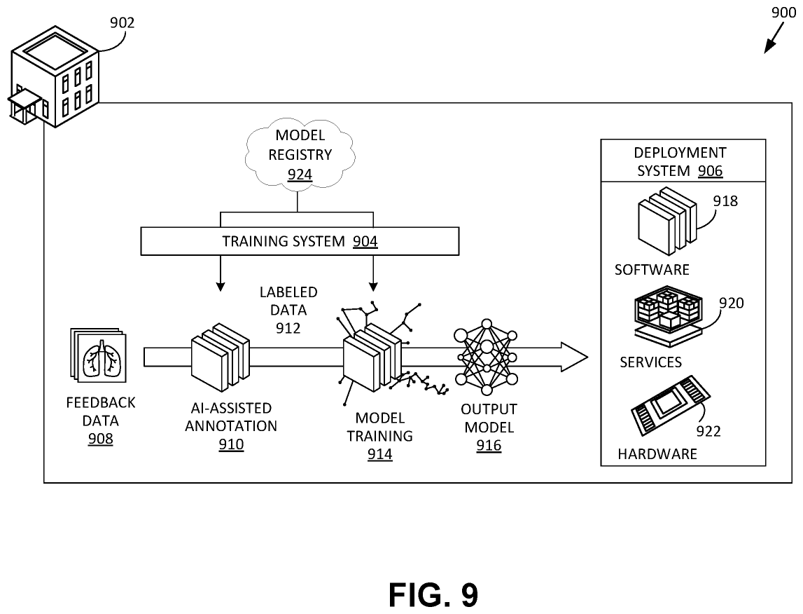

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

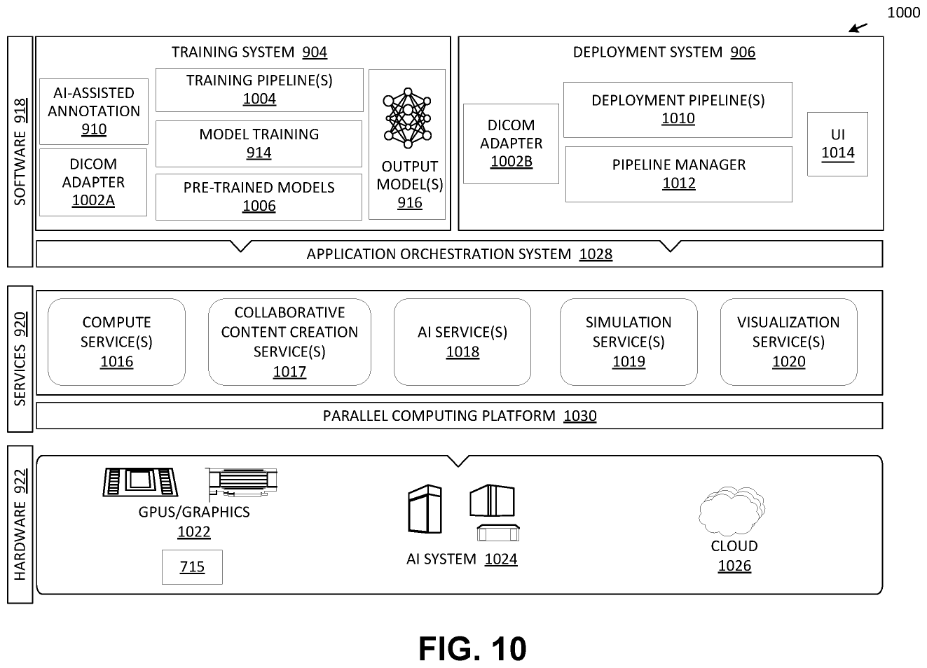

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914 may include data—e.g., AI-assisted annotations 910, labeled data 912, or a combination thereof—that may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., system 1000 of FIG. 10). In at least one embodiment, once validated by system 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example system 1000 for generating and deploying a deployment pipeline, according to at least one embodiment. In at least one embodiment, system 1000 may be used to implement process 900 of FIG. 9 and/or other processes including advanced processing and inferencing pipelines. In at least one embodiment, system 1000 may include training system 904 and deployment system 906. In at least one embodiment, training system 904 and deployment system 906 may be implemented using software 918, services 920, and/or hardware 922, as described herein.

In at least one embodiment, system 1000 (e.g., training system 904 and/or deployment system 906) may implemented in a cloud computing environment (e.g., using cloud 1026). In at least one embodiment, system 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1000, may be restricted to a set of public internet service providers (ISPs) that have been vetted or authorized for interaction.

In at least one embodiment, various components of system 1000 may communicate between and among one another using any of a variety of different network types, including but not limited to local area networks (LANs) and/or wide area networks (WANs) via wired and/or wireless communication protocols. In at least one embodiment, communication between facilities and components of system 1000 (e.g., for transmitting inference requests, for receiving results of inference requests, etc.) may be communicated over a data bus or data busses, wireless data protocols (e.g., Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904 and may be implemented by deployment system 906.

In at least one embodiment, output model(s) 916 and/or pre-trained model(s) 1006 may include any types of machine learning models depending on embodiment. In at least one embodiment, and without limitation, machine learning models used by system 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, system 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and interact with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of the applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within system 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure an appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel-level segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of system 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of system 1000.

In at least one embodiment, cloud 1026 may include a GPU-accelerated infrastructure (e.g., NVIDIA's NGC™) that may provide a GPU-optimized platform for executing processing tasks of system 1000. In at least one embodiment, cloud 1026 may include an AI system(s) 1024 for performing one or more of AI-based tasks of system 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of system 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
receiving an identification of a plurality of machine learning models (MLMs) for execution on a set of computational resources;
obtaining execution metrics characterizing expected utilization of the set of computational resources during execution of individual MLMs of the plurality of MLMs;
generating a first batch queue comprising one or more MLM batches, wherein at least one MLM batch comprises one or more MLMs of the plurality of MLMs, at least one MLM batch having a combined expected utilization of the set of computational resources not exceeding a threshold utilization; and
initiating parallel execution of a first MLM batch of the one or more MLM batches of the first batch queue.

2. The method of claim 1, wherein the execution metrics characterizing expected utilization of the set of computational resources include at least one of:
a size of input data into an MLM of the plurality of MLMs,
a total memory used during execution of the MLM,
a peak memory use during execution of the MLM, or
a peak processing clock speed during execution of the MLM.

3. The method claim 1, wherein the execution metrics further include expected utilization of one or more virtual processing units supported by the set of computational resources.

4. The method of claim 1, wherein obtaining the execution metrics for an MLM of the plurality of MLMs comprises:
collecting the execution metrics during individual execution of the MLM.

5. The method of claim 4, further comprising:
storing the collected execution metrics in a memory device.

6. The method of claim 1, wherein obtaining the execution metrics for an MLM of the plurality of MLMs comprises estimating the execution metrics for the MLM using one or more of:
an architecture of the MLM,
a size of an input into the MLM,
a number of computational operations associated with the MLM, or
one or more number formats used by the computational operations associated with the MLM.

7. The method of claim 1, wherein the combined expected utilization of the set of computational resources by the first MLM batch characterizes expected utilization of memory resources during parallel execution of one or more MLMs of the first MLM batch.

8. The method of claim 7, wherein the combined expected utilization of the set of computational resources by the first MLM batch characterizes expected utilization of one or more processing units during parallel execution of the one or more MLMs of the first MLM batch.
The method of claim 1, wherein of the set of computational resources comprises at least one of a central processing unit (CPU), a data processing unit (DPU), or a graphics processing unit (GPU).

9. The method of claim 1, further comprising:
initiating, concurrently with the parallel execution of the first MLM batch, parallel execution of a second MLM batch of the one or more MLM batches of the first batch queue, the first MLM batch and the second MLM batch being executed on:
two or more separate graphics processing units (GPUs), or
two or more separate virtual GPUs supported by a same GPU.

10. The method of claim 1, further comprising:
responsive to completing execution of the first MLM batch, initiating parallel execution of a second MLM batch of the one or more MLM batches of the first batch queue.

11. The method of claim 1, further comprising:
subsequent to initiating execution of the first MLM batch, generating at least a second batch queue, wherein the second batch queue comprises at least one MLM batch that is different from at least one other MLM batch of the first batch queue.

12. The method of claim 12, further comprising:
determining first performance metrics associated with execution of the first batch queue;
computing second performance metrics associated with prospective execution of the second batch queue; and
responsive to a comparison of the first performance metrics and the second performance metrics, switching from the execution of the first batch queue to an execution of the second batch queue.

13. The method of claim 12, further comprising:
displaying a first efficiency report to a user, wherein the first efficiency report comprises runtime performance metrics associated with execution of the first batch queue;
displaying a second efficiency report to the user, wherein the second efficiency report comprises estimated performance metrics associated with prospective execution of the second batch queue; and
responsive to receiving, from the user, a selection of the second batch queue, switching from execution of the first batch queue to execution of the second batch queue.

14. The method of claim 12, further comprising:
storing at least one of the first batch queue or the second batch queue in a memory device.

15. The method of claim 1, wherein generating the first batch queue comprises:
forming, using a priority metric, a priority queue for the plurality of MLMs; and
performing a plurality of MLM placement operations, wherein individual MLM placement operations comprise:
selecting a next MLM in the priority queue;
placing the selected MLM, using the threshold utilization and the execution metrics for the selected MLM, into at least one of:
an existing MLM batch of the first batch queue, or
a new MLM batch of the first batch queue.

16. A system comprising:
a memory device; and
a processor, communicatively coupled to the memory device, to:
receive an identification of a plurality of machine learning models (MLMs) for execution on a set of computational resources;
obtain execution metrics characterizing expected utilization of the set of computational resources during execution of individual MLMs of the plurality of MLMs;
generating a first batch queue comprising one or more MLM batches, wherein each MLM batch comprises one or more MLMs of the plurality of MLMs, each MLM batch having a combined expected utilization of the set of computational resources not exceeding a threshold utilization; and
initiate parallel execution of a first MLM batch of the one or more MLM batches of the first batch queue.

17. The system of claim 17, wherein to obtain the execution metrics for an MLM of the plurality of MLMs, the processing device is to perform at least one of:
collect the execution metrics during individual execution of the MLM; or. estimate the execution metrics for the MLM using one or more of:
an architecture of the MLM,
a size of an input into the MLM,
a number of computational operations associated with the MLM, or
one or more number formats used by the computational operations associated with the MLM.

18. The system of claim 17, wherein the combined expected utilization of the set of computational resources by the first MLM batch characterizes at least one of:
an expected utilization of memory resources during parallel execution of one or more MLMs of the first MLM batch, or
an expected utilization of one or more processing units during parallel execution of the one or more MLMs of the first MLM batch.

19. The system of claim 17, wherein the processing device is further to:
subsequent to initiating execution of the first MLM batch, generate at least a second batch queue, wherein the second batch queue comprises at least one MLM batch that is different from each MLM batch of the first batch queue;
determine first performance metrics associated with execution of the first batch queue;
compute second performance metrics associated with prospective execution of the second batch queue; and
responsive to a comparison of the first performance metrics and the second performance metrics, switching from the execution of the first batch queue to an execution of the second batch queue.

20. The system of claim 17, wherein the system is comprised in at least one of:
a control system for an autonomous or semi-autonomous machine;
a perception system for an autonomous or semi-autonomous machine;
a system implemented using one or more application programming interfaces;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of augmented reality content, virtual reality content, or mixed reality content;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

21. A processor comprising processing circuitry to perform operations comprising:
receiving an identification of a plurality of machine learning models (MLMs) for execution on a set of computational resources;
obtaining execution metrics characterizing expected utilization of the set of computational resources during execution of individual MLMs of the plurality of MLMs;
generating a first batch queue comprising one or more MLM batches, wherein at least one MLM batch comprises one or more MLMs of the plurality of MLMs, at least one MLM batch having a combined expected utilization of the set of computational resources not exceeding a threshold utilization; and
initiating parallel execution of a first MLM batch of the one or more MLM batches of the first batch queue.
